(19) United States
(12) Patent Application Publication
(10) Pub. No.: US 2024/0319565 A1
(43) Pub. Date: Sep. 26, 2024

(54) Support Device for Close-Up Photography with Adjustable Lighting and Fixed Focus Distance

(71) Applicants: Haluk Un, WOODINVILLE, WA (US); MUSTAFA YASAR SIR, WOODINVILLE, WA (US)

(72) Inventors: Haluk Un, WOODINVILLE, WA (US); MUSTAFA YASAR SIR, WOODINVILLE, WA (US)

(21) Appl. No.: 18/609,072

(22) Filed: Mar. 19, 2024

Related U.S. Application Data
(60) Provisional application No. 63/453,343, filed on Mar. 20, 2023.

(51) Int. Cl. G03B 11/04; G03B 7/18; G03B 17/56

(52) U.S. Cl. CPC G03B 11/045; G03B 7/18; G03B 17/561

(57) ABSTRACT

The present disclosure pertains to a support device designed to enhance the quality of close-up photography. The device features a hollow body with one or more side walls that extend between a top portion and a base portion, defining an interior space. The top portion of the device is equipped with a structure configured to securely hold an image capture device, such as a smartphone or camera, in a fixed orientation. This orientation aligns the camera lens of the image capture device with a first viewing opening at the top portion, directing it towards a second viewing opening at the base portion. The second viewing opening is surrounded by a bottom edge of the base portion and is positioned at a predetermined distance from the first viewing opening, establishing a fixed field of view for the image capture device.

### FIELD OF INVENTION

The present invention relates generally to the field of photography accessories, specifically to a support device designed to enhance the quality of close-up photographs taken with mobile electronic devices. It focuses on improving image resolution and clarity through controlled lighting and stable positioning.

### BACKGROUND

In the realm of close-up photography, particularly in capturing detailed images of skin surfaces, existing methodologies and apparatus have been met with significant limitations. The essence of high-resolution imaging necessitates the proximity of the camera to the subject, necessitating a stable platform to mitigate any movement that could compromise image quality. Moreover, the manipulation of lighting—both in terms of intensity and direction—presents another layer of complexity essential for achieving the desired clarity and detail in photographs. Current solutions aim to address these challenges by offering means to fix the photographic device at a certain distance from the subject. However, these solutions fall short in several aspects.

Adjusting the distance and angle of the electronic device relative to the subject remains a cumbersome task, exacerbated when photographing the nuanced textures of human skin where the depth and three-dimensional characteristics of lesions such as papules or vesicles demand precise lighting conditions for accurate representation. Existing devices do not afford the flexibility required to modify the external lighting conditions effectively, thereby limiting the photographer's ability to capture the true essence of the subject matter.

Further complicating the matter is the requirement that the photographic device be utilized across a variety of angles and positions, especially when dealing with uneven surfaces such as the human body. This necessitates a support device that not only accommodates these variations but also ensures a secure attachment to the electronic device to prevent slippage and maintain stability during the photographic process.

Moreover, the need for a support device that is both compact and user-friendly cannot be overstated. Compatibility with a diverse range of electronic devices enhances its utility, suggesting a design that incorporates foldable, adaptable materials to cater to the varying dimensions and models of mobile devices.

Existing solutions in the realm of portable imaging and photographic assistance devices have shown considerable limitations in their design and functionality, impacting their versatility and effectiveness in various photographic situations. Notably, patents such as WO2017087381A1 describe portable image diagnostic apparatuses that are constrained by their hard molded shape, rendering them incompatible with devices of different shapes. This limitation significantly restricts their utility across the diverse range of image capture devices available in the market.

Similarly, a group of patents including KR101563400B1, U.S. Pat. No. 10,667,694B2, US20170199445A1, US20130057927A1, and others, highlight a common deficiency in their inability to adjust incoming light or to offer foldability. Such shortcomings diminish their applicability in dynamic photographic conditions where controlling light intensity and direction is crucial for capturing high-quality images. The rigidity and lack of adjustability in these devices also hinder their convenience and portability, aspects that are increasingly demanded by users seeking flexible and effective photographic solutions.

Further analysis of patents like KR102421868B1, JP2012042902A, and US10684231B2 reveals a continued trend of limitations in light control. These devices fail to offer mechanisms for effectively managing the lighting within the photographic environment, a critical factor for achieving desired image outcomes, particularly in close-up photography where the nuances of light play a pivotal role in image quality.

Additionally, devices such as CN103246149B and U.S. Pat. No. 5,285,226A, while aimed at supporting mobile photography and image processing, are not designed with foldability in mind, nor do they allow for the adjustment of incoming light. This lack of flexibility further constrains their use with differently shaped devices, thereby limiting their universal applicability.

The deficiency is further exemplified in devices and methods like CN215067671U, which, despite aiming to facilitate operational shooting, do not provide sufficient control over incoming light nor offer a secure and adaptable means to hold various devices. This oversight underscores the necessity for a support device that can not only accommodate devices of varying shapes and sizes but also offer enhanced control over lighting conditions to cater to the specific needs of the subject being photographed.

Moreover, the existing solutions do not adequately address the need for versatility in photographing objects at different angles and on uneven surfaces. The requirement for a support device that can secure the electronic device in a manner that allows for easy manipulation, without slipping or requiring a perfectly flat surface, is evident. This need is particularly acute in applications such as medical photography, where capturing images of the human body from various angles and positions is often necessary to achieve diagnostic quality images.

It is within this context that the present invention is provided.

### SUMMARY

The present invention relates to a support device designed to facilitate close-up photography. This device comprises a hollow body with one or more side walls extending between a top portion and a base portion. The top portion is equipped with a structure to hold an image capture device in a fixed orientation, allowing the camera lens of the device to align with a first viewing opening directed towards a second viewing opening at the base portion. This configuration ensures a fixed field of view for the image capture device, enhancing the quality of close-up photographs.

In some embodiments, the hollow body of the support device is designed to transition between a flat state for convenient storage and a three-dimensional state for active use. This feature, facilitated by foldable regions along the side walls, offers significant versatility and ease of transportation for the user.

Further embodiments include adjustable side covers located on the one or more side walls. These covers are operable to modulate the light entering the interior space of the hollow body, thereby allowing users to control the lighting conditions for optimal photography outcomes.

In certain embodiments, the one or more side walls of the hollow body incorporate transparent or translucent materials. These materials are capable of filtering light to adjust the lighting conditions within the hollow body, providing the advantage of enhancing image quality under varying light conditions.

Additionally, at least one opening equipped with a filter element can be found on the one or more side walls in some embodiments. This filter element, being interchangeable, offers the user the ability to produce different lighting effects within the interior space, thus adapting to the specific requirements of the subject being photographed.

In some embodiments, the bottom edge of the base portion includes indentations, protrusions, or a combination thereof. This design enhances the grip of the support device on the surface upon which it is placed, ensuring stability during use.

The structure configured to retain the image capture device may comprise a frame or platform with adjustable grip elements in certain embodiments. This allows the support device to accommodate different sizes and models of image capture devices, increasing its versatility.

Some embodiments further comprise adhesive parts located on the structure for securing the image capture device. These adhesive parts are designed to prevent movement of the image capture device once installed, ensuring consistent image quality.

In another embodiment, the hollow body includes a foldable box-like structure at the top portion. This structure facilitates the insertion and securing of the image capture device, with foldable flaps to adjust to the size of the device, offering flexibility in device compatibility.

The hollow body can be made from a variety of materials, including paper, plastic, wood, metal, fabric, and silicone, in some embodiments. The selection of material provides a desired level of transparency or opacity, catering to the specific needs of the photographic task.

A base surface structure attached to the bottom edge of the base portion is included in some embodiments. This base surface includes measurement markings to assist in the evaluation of dimensions of the subject being photographed, adding functionality for precise imaging.

In further embodiments, the base surface is configured with mechanisms to prevent small objects from getting too close to the camera lens of the image capture device. This maintains a fixed focus distance, crucial for consistent close-up image quality.

The hollow body can be formed into a variety of geometric shapes to accommodate different photographic requirements in certain embodiments. This adaptability allows the device to be used in a wide range of photographic scenarios.

Lastly, some embodiments are configured to work in conjunction with artificial intelligence models to optimize settings such as stability, lighting, distance, and zoom. This integration enhances the quality of the captured images by utilizing classifiers for image-quality assessment, deep learning models for assisting in the optimal positioning of the device, and deep learning-based pixel-level image fusion models to produce the final image. This technological integration represents a significant advancement in the field of photography accessories, aiming to streamline the process of capturing high-quality close-up images.

### BRIEF DESCRIPTION OF THE DRAWINGS

Various embodiments of the invention are disclosed in the following detailed description and accompanying drawings.

FIG. 1A is a perspective view of an example configuration of the support device.

FIG. 1B is a top view of an example configuration of the support device.

FIG. 1C is a perspective view of an example configuration of the support device.

FIGS. 2A, 2B, and 2C are perspective views of an example configuration of the support device with the electronic device installed.

FIG. 3A is a perspective view of an example configuration of the support device in a stationary position.

FIG. 3B is a perspective view of an example configuration of the support device in a folded position.

FIG. 3C is a perspective view of an example configuration of the support device from a perspective view.

FIG. 4A is a perspective view of an example configuration of the support device in a folded position.

FIG. 4B is a view of an example configuration of the support device with the edges spread out flatly.

FIG. 5A is a perspective view of an example configuration of the support device.

FIG. 5B is a perspective view of an example configuration of the support device with the electronic device.

FIG. 5C is a side view of an example configuration of the support device.

FIG. 6A is a front view of an example configuration of the support device.

FIG. 6B is a side view of an example configuration of the support device with the electronic device.

FIG. 7 is a cross-sectional front view of an example configuration of the support device with the electronic device.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” indicate an acceptable degree of error or variation in measurements, usually within 20%, preferably within 10%, and more preferably within 5% of a given value or range. Numerical values provided in this description are approximate unless stated otherwise.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

As used herein, “hollow body” refers to any structure defining an enclosed or semi-enclosed space, capable of accommodating an image capture device. The hollow body may be constructed from a variety of materials, including but not limited to paper, plastic, wood, metal, fabric, and silicone. The specific material chosen may depend on the desired properties such as durability, flexibility, transparency, or opacity. The hollow body's shape and size can vary to support different models and sizes of image capture devices, ranging from compact smartphones to larger cameras.

The term “image capture device” as described herein encompasses a wide range of photographic equipment capable of capturing images. This includes, but is not limited to, digital cameras, smartphones with built-in cameras, tablets with camera capabilities, and other portable electronic devices equipped with image capturing functionalities. The invention is designed to adapt to various image capture device configurations, including different lens positions and device dimensions, ensuring compatibility across a broad spectrum of devices.

“Adjustable side covers,” as mentioned in the present invention, refer to movable or reconfigurable elements attached to or integrated within the hollow body's side walls. These covers can be manipulated to alter the interior space's lighting conditions, either by blocking, filtering, or redirecting light. The covers may be made from materials including, but not limited to, transparent, translucent, or opaque substances, and can include features such as filters or flaps. The adjustment mechanisms can vary, including hinges, sliders, or removable elements, providing flexibility in controlling the light entering the hollow body.

In the context of this disclosure, “fixed orientation” implies that the image capture device is held in a specific position or angle relative to the hollow body, ensuring that the device's camera lens is consistently aligned with the viewing openings. This orientation facilitates precise focus and framing for close-up photography. The mechanism for maintaining this fixed orientation may include, but is not limited to, grip elements, adjustable frames, or adhesive parts designed to securely position the image capture device without obstructing the lens or interfering with the device's functionality.

### DESCRIPTION OF DRAWINGS

The present invention relates to a support device designed to enhance the capabilities of close-up photography. Central to the invention is a hollow body characterized by one or more side walls, culminating in a top portion that forms a first viewing opening and a base portion that forms a second viewing opening. This structural design is foundational to the device's functionality in improving the quality and precision of close-up images.

The top portion of the device is equipped with a structure specifically configured to hold an image capture device, such as a mobile phone, in a stable, fixed orientation. This is typically achieved through a frame structure with an opening to slot the device into or a platform equipped with grip elements that secure the device atop the structure. The strategic design ensures that the camera lens of the installed image capture device aligns with the first viewing opening, directing its focus through to the second viewing opening located at the base portion.

The base portion features a bottom edge that encircles the second viewing opening, set at a precise distance from the first viewing opening to define a fixed field of view for the image capture device. Notably, the second viewing opening is generally wider than the first, with the side walls flaring outward. This configuration ensures that the image capture device, once positioned, benefits from a consistent field of view at a predetermined distance, crucial for capturing detailed close-up photographs.

In practical application, the bottom edges of the base portion are positioned on a surface—such as a section of human skin—allowing the image capture device to photograph the area visible through the second viewing opening. This capability is particularly valuable in fields requiring detailed visual documentation, such as dermatology or material science.

To further enhance the device's versatility and adaptability to various lighting conditions and photographic requirements, modifications can be made to the side walls. These modifications may include the introduction of opening flaps and filters, allowing users to manipulate the internal lighting conditions of the hollow body. Such adaptability ensures that the support device can facilitate optimal photography across a range of environments and subject matters, tailoring the lighting to meet specific needs without compromising on image quality. Through this thoughtful design, the invention offers a practical solution to the challenges of close-up photography, enabling users to achieve high-quality photographic results with ease and consistency.

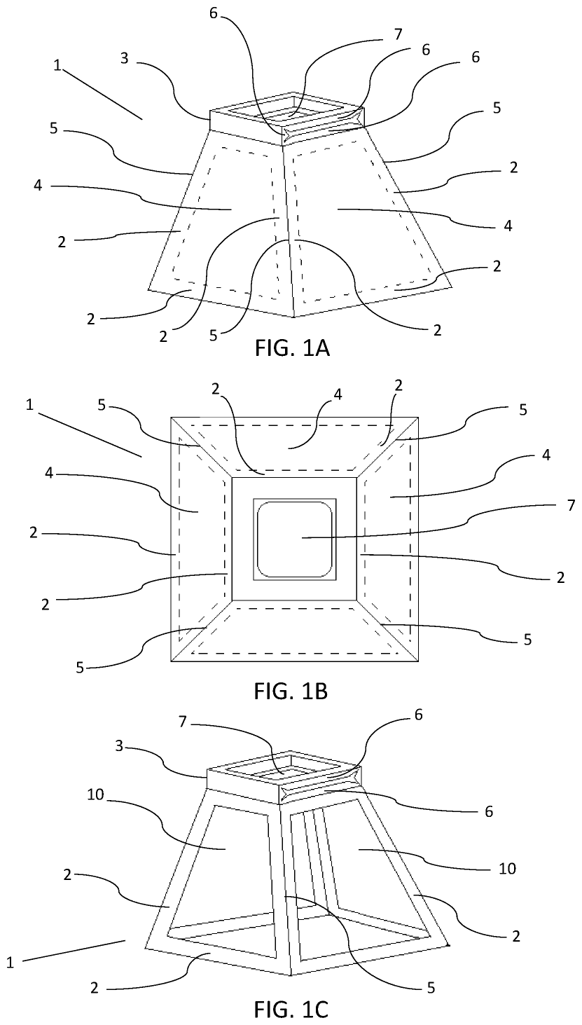

FIG. 1A provides a perspective view of the support device, designated as (1). This figure illustrates the support device (1) as comprising two distinct components. The lower segment features flat edges (2) equipped with support legs for stability. The upper segment contains a section (3) designed to secure the electronic device (8). These edges (2) ensure that the electronic device (8) is maintained in a steady, fixed position at a specified distance from the photographed object. Integrated into the edges (2) are hinged covers (4), which can be manipulated to either fully close, partially open, or remain entirely open, depending on the user's preference for lighting control. The support device (1) transitions from a flat to a three-dimensional structure through foldable regions (5), allowing for easy storage and setup.

In the same figure, the top part of the support device (1) showcases the electronic device holding structure (3), which can be integrated with or separate from the main body of the support device (1). This structure (3) features half covers (6) that adapt to the size of the electronic device (8), securing it in place. An opening (7) on this structure allows for external access to the electronic device's screen (9), facilitating interaction without removing the device. This opening (7) may also be fitted with a transparent cover to enable touchscreen functionality. Additionally, this structure (3) is designed to be foldable, enhancing the device's adaptability and compactness.

FIG. 1B presents a top-down view of the support device (1), highlighting an opening (7) that extends from the top to the bottom of the device. This arrangement directs the electronic device's (8) viewing area towards the bottom of the support device (1), while simultaneously providing access to the device from the top. The support device (1) may assume various forms, including but not limited to square, polygonal, elliptical, or circular shapes, with options for both symmetrical and asymmetrical designs, offering versatility in its application and aesthetic appeal.

FIG. 1C depicts a perspective view where the side covers (4) of the support device (1) can either be fully opened by the user or adjusted to a desired position. These covers (4) may also be equipped with transparent materials, optionally colored or featuring light-filtering properties, to customize the lighting environment within the support device (1). This feature allows for enhanced control over the photographic conditions, facilitating the capture of images under varied lighting scenarios.

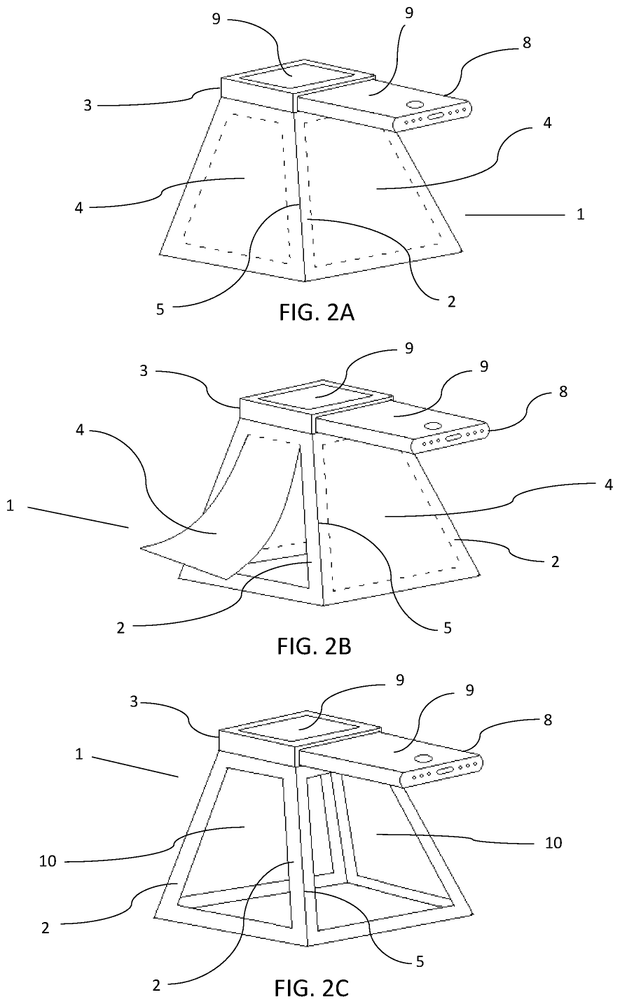

FIG. 2A illustrates the electronic device (8) positioned atop the support device (1). The configuration ensures that the imaging component of the electronic device (8) faces inward toward the support device (1), facilitating targeted image capture, while the screen part (9) remains visible and accessible from the exterior. This arrangement allows the electronic device (8) to integrate seamlessly with the support device (1), enabling them to function as a unified entity during use.

In FIG. 2B, the adjustability of the side covers (4) is showcased. These covers (4) are designed to offer flexibility in controlling the internal lighting conditions of the support device (1). Users have the option to detach the covers (4) completely from the edges (2) or adjust them to remain partially attached, providing a range of lighting configurations to suit different photographic needs. This feature underscores the support device's adaptability in managing light exposure for optimal image capture.

FIG. 2C expands on the modifiability of the support device (1) by demonstrating that all side covers (4) can be entirely removed, opening up all sides (10) of the device. This open configuration maximizes the potential for light entry, which can be finely tuned by applying a transparent layer over these openings. The introduction of a transparent layer, following the removal of the opaque covers (4), offers the user enhanced control over the quantity and quality of light permeating the support device (1), thus accommodating a broad spectrum of photographic conditions and preferences. This capability to modify the device's lighting environment further exemplifies the support device's versatility in facilitating high-quality close-up photography.

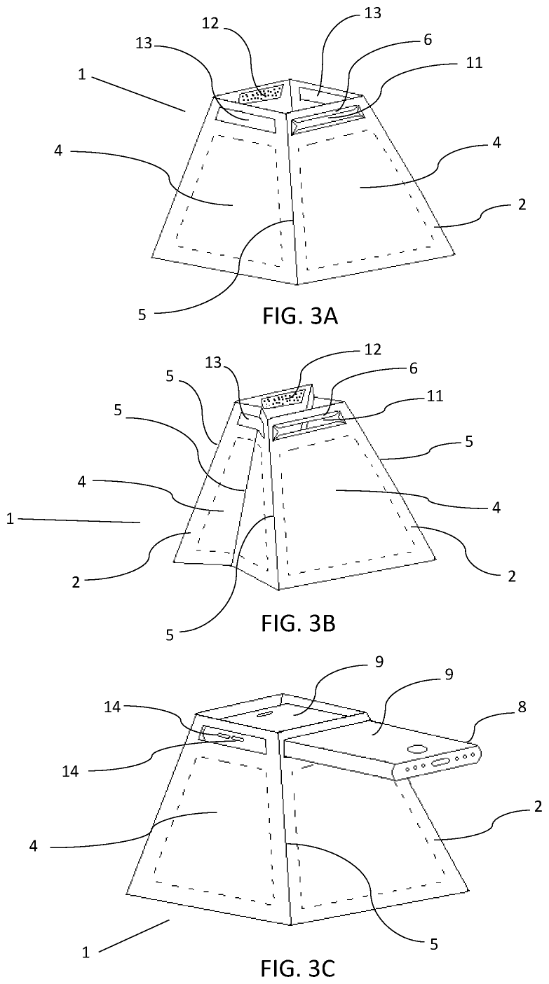

In FIG. 3A, the section designed to hold the electronic device, referred to as (3), is integrated with the overall structure of the support device (1). This integration is achieved through the inclusion of clearances (11) along the upper sides of the support device (1), designated for positioning the electronic device (8). Accompanying these clearances (11) are half covers (6) that are engineered to fold inward, adapting to the dimensions of the electronic device (8) to secure it firmly in place. This adaptability ensures the electronic device (8) maintains a stable orientation within the support device (1). Additionally, adhesive surfaces (12) are strategically placed on the inner surface of the support device (1) to enhance the device's grip on the electronic device (8), with the option of applying removable non-stick layers to these adhesive areas to prevent residue or unwanted adherence.

FIG. 3B presents a perspective view of the support device (1) in its compact, folded state. This figure illustrates the capability of the support device (1) to minimize its footprint for storage or transportation by folding along its edges, either inward or outward. The design allows for a versatile adjustment of the device's form factor, transitioning from a flat to a three-dimensional structure based on usage requirements. The location and number of folding points are variable, offering flexibility in how the support device (1) is configured and deployed.

FIG. 3C depicts the support device (1) with the electronic device (8) installed. The electronic device (8) is inserted through an opening at the top of the support device (1), ensuring contact with the adhesive surface (12) to establish a secure connection. This arrangement is further reinforced by the half covers (6), which interact with the electronic device (8) to prevent displacement. Openings (13) on the upper edge of the support device (1) facilitate access to the electronic device's (8) controls, such as buttons (14), while the open top design allows the electronic device's screen (9) to remain visible and accessible. This configuration underscores the support device's functionality in securely accommodating the electronic device (8) while maintaining usability and interactive capabilities.

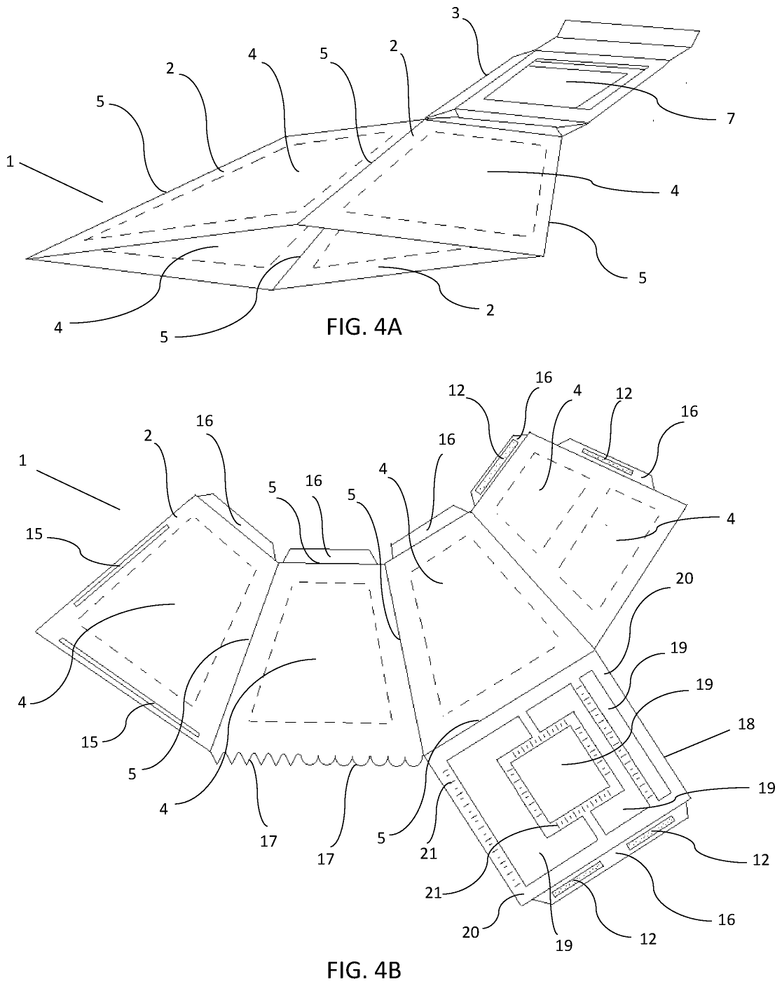

FIG. 4A provides a perspective view of the support device (1) in its compact, folded configuration, highlighting its space-efficient design when not actively in use. The foldable nature of the support device (1) is demonstrated through edges (5) that can be adjusted inward or outward, minimizing the device's footprint for storage or transport. The section that secures the electronic device (8), labeled as (3), shares this foldable characteristic, enhancing the support device's (1) overall versatility. This holding section (3) can be connected to the main body of the support device (1) along one or more of its edges, or it may be a detachable component, offering flexibility in how the electronic device (8) is mounted.

FIG. 4B shows the support device (1) with its edges extended to lay flat, illustrating the device's preparatory state prior to use. This flat configuration, facilitated by foldable edges (5), is designed for ease of setup, with pre-folded or specially designed structures to simplify the transformation into a three-dimensional shape. Openings (15) and extensions (16) located on the edges (2) interlock to maintain the device's structural integrity in its operational form. Adhesive parts (12) located on these extensions (16) secure the electronic device (8) in place and contribute to the stability of the support device's (1) structure. The design includes indented or curved edges (17) at the base to prevent slipping on various surfaces, enhancing the device's usability on uneven or smooth surfaces alike.

A distinct base surface (18) complements the bottom of the support device (1), equipped with open areas (19) to facilitate unobstructed imaging. Surrounding these openings are thin strips (20), potentially equipped with measurement markers (21), aiding in the accurate assessment of object dimensions and maintaining a consistent distance between the camera and the subject. This feature is critical for ensuring clarity and focus in the captured images, especially when photographing irregular surfaces such as body parts. The transparent nature of these strips (20) and the strategic design of the base surface (18) not only support precise imaging but also preserve the three-dimensional structure of the support device (1) by keeping its edges (2) aligned. Additionally, adjustable covers (4) on the edges (2) offer further control over lighting conditions, enabling users to modify the environment within the support device (1) to achieve optimal photographic results.

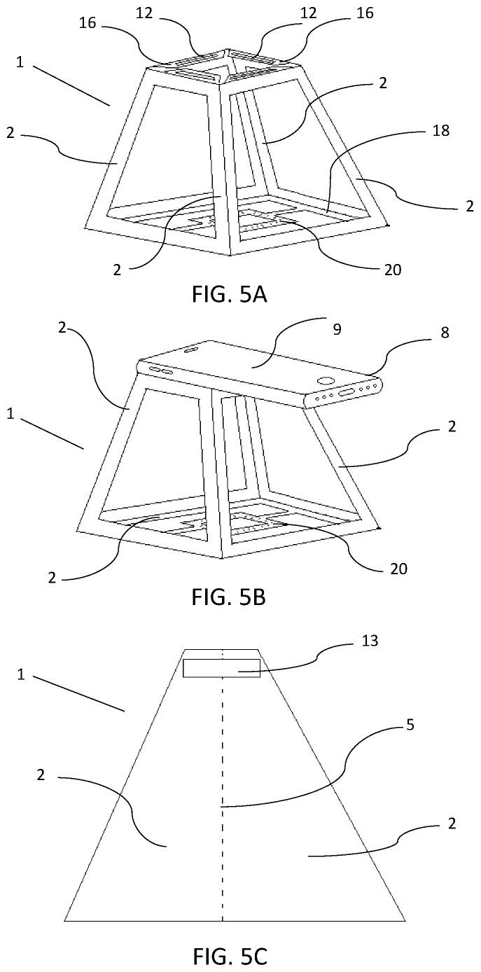

FIG. 5A offers a perspective view of the support device (1), demonstrating its transition from a planar structure to a three-dimensional form, as previously unfolded in FIG. 4B. The edge extensions (16), located at the top of the support device (1), are strategically folded to orient the adhesive surfaces (12) upwards, facilitating secure attachment of the electronic device (8). The base surface (18) acts as a unifying element, connecting the side edges (2) and ensuring the structural integrity and stability of the support device (1) in its operational state. Positioned on the base of the support device (1), the strips (20) are aligned parallel to the imaging surface, ready to support precise photography by maintaining a consistent distance to the subject.

In FIG. 5B, the support device (1) is shown in conjunction with the electronic device (8), illustrating how the electronic device (8) is mounted onto the support device (1). The adhesive surfaces (16) on the top of the support device (1) secure the electronic device (8) in place, creating a unified assembly that enhances the stability and functionality of the setup for optimal imaging performance.

FIG. 5C presents a side view of the support device (1), highlighting the tapered design where the top of the device is narrower compared to the base. This design facilitates easy access to the electronic device's (8) buttons (14) through openings (13) provided on the top of the support device (1), ensuring user control over the device without needing to disassemble the setup. The inclusion of foldable connections (5) along the edges (2) permits adjustment in any direction, allowing the support device (1) to adapt to various operational requirements by folding towards either the inner or outer surfaces. This adaptability ensures that the support device (1) can be customized for different imaging scenarios, further enhancing its utility in close-up photography.

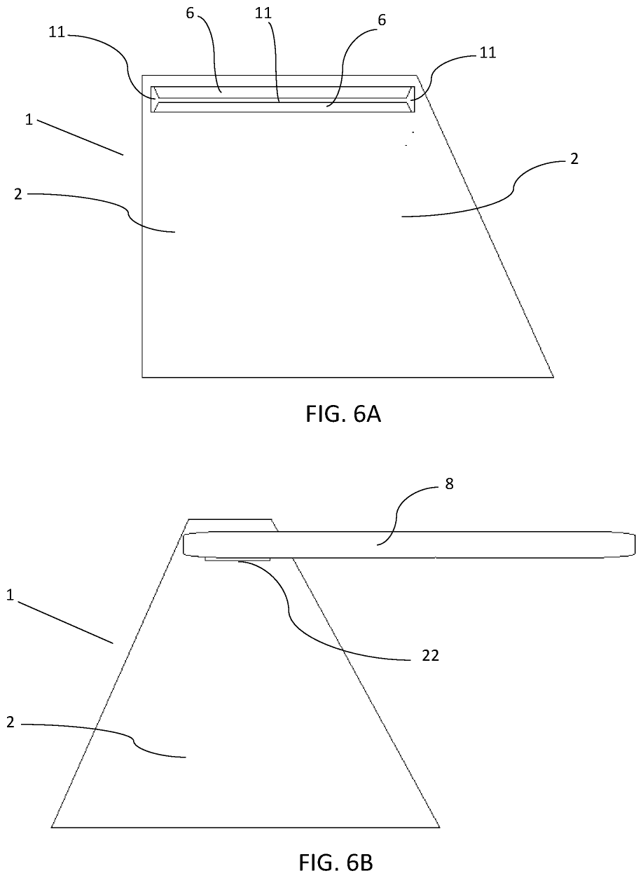

FIG. 6A presents a front view of the support device (1), detailing the presence of semi-open covers (6) within the clearances (11) at the top. These covers (6) are designed to adjust based on the dimensions of the electronic device (8), ensuring a secure fit. The architecture of the edge sections (2) of the support device (1) allows for both symmetry and asymmetry, accommodating various design preferences. The orientation of these edges (2) relative to the base surface can vary, being either perpendicular or angled, to suit different imaging requirements.

FIG. 6B displays a side view of the support device (1) with an electronic device (8) installed. This illustration shows the electronic device (8) positioned such that its camera (22) points towards the base of the support device (1), aligning the lens for optimal image capture without interference from the device's structure.

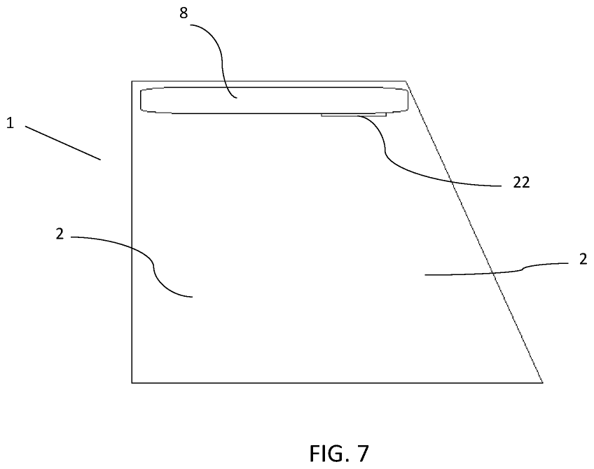

FIG. 7) offers a front-sectional view of the support device (1) in conjunction with the electronic device (8). In this configuration, the camera (22) of the electronic device (8) is oriented to focus on the base area of the support device (1), ensuring clear and unobstructed image capture. This effectiveness is maintained regardless of the symmetry or asymmetry of the support device's (1) edges (2).

The materials constituting the support device (1), including the body, the section holding the electronic device, and the side covers, may be comprised of plastic, rubber, silicone, fabric, or other industry-standard materials. These components can be crafted from a single material type or a combination thereof, utilizing manufacturing processes such as molding or cutting to achieve the desired form factor.

The construction of the support device (1) allows for individual or combined production of its various components. These parts can be assembled into a cohesive unit using single or multiple molds, or they can be manufactured separately and assembled post-production. This modular approach facilitates customization and adaptation to specific user needs or device specifications.

Moreover, the support device (1) is capable of integrating with artificial intelligence (AI) models to refine its functionality, including optimizing stability, lighting, distance, and zoom. The application of AI can significantly enhance image quality, utilizing classifiers for image quality assessment, deep learning models for device positioning, and pixel-level image fusion models for generating the final photograph. These technological integrations underscore the support device's adaptability and advanced capability in improving the photography experience.

The described features and configurations of the support device (1) illustrate its versatility and potential for customization, catering to a wide range of photographic needs and preferences. These elements can be employed individually or in various combinations, underscoring the device's flexibility in meeting diverse imaging requirements.

The entirety or each component comprising the support device (1) can be produced from biodegradable, compostable, or recyclable materials. Biodegradable plastics encompass polylactic acid (PLA), polyhydroxyalkanoates (PHA), polybutylene adipate terephthalate (PBAT), polycaprolactone (PCL), starch-based plastics, and bioplastic PET (Bio-PET). These materials, which are not limited to those mentioned, include the following characteristics: These materials, derived from renewable resources or modified from traditional plastics, offer environmentally friendly alternatives that naturally break down over time, reducing pollution and waste accumulation. Compostable materials may originate from organic matter, cellulose, or paper, while recyclable materials may include paper, glass, or metal. The stethoscope can also be produced as a combination of various materials. Production methods may include one or more of the following steps: injection molding, cutting, assembling, welding.

The production can be carried out using the following methods: The continuous flow biodegradable or recyclable plastic production method comprises several interconnected steps. Initially, biodegradable polymer pellets or granules are fed into a mixing chamber where they are combined with additives and modifiers to achieve desired material properties. The mixture is then conveyed into an extrusion unit equipped with a twin-screw extruder. Within the extruder, the polymer blend is heated, melted, and homogenized under controlled temperature and pressure conditions. Following extrusion, the molten polymer is directed into a shaping die assembly designed to impart specific geometries to the plastic products. The die assembly may include interchangeable molds or nozzles to facilitate the production of various shapes and sizes. As the plastic material exits the die, it undergoes rapid cooling and solidification, preserving the desired form. To enhance the biodegradability of the final products, the manufacturing process can incorporate additives such as bio-based fillers, enzymes, or microbial agents that accelerate decomposition in natural environments. These additives are carefully integrated into the polymer blend during mixing to ensure uniform distribution and effectiveness. Additionally, the continuous flow nature of the production line enables high throughput and efficiency, minimizing downtime and waste. Automated monitoring and control systems oversee key process parameters, ensuring consistent product quality and performance. The disclosed continuous flow biodegradable plastic production method offers a sustainable approach to plastic manufacturing, utilizing renewable resources and environmentally friendly practices to produce biodegradable plastics suitable for a wide range of applications.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the support device of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A support device for facilitating close-up photography, comprising:
a hollow body having one or more side walls extending between a top portion and a base portion, wherein the hollow body defines an interior space;
the top portion including a structure configured to retain an image capture device in a fixed orientation, such that a camera lens of the image capture device, when installed, aligns with a first viewing opening defined by the top portion to direct towards a second viewing opening defined by the base portion;
the base portion including a bottom edge surrounding the second viewing opening, wherein the second viewing opening is positioned at a predetermined distance from the first viewing opening to establish a fixed field of view for the image capture device.

2. The support device of claim 1, wherein the hollow body is configurable between a flat state for storage and a three-dimensional state for use, facilitated by foldable regions located along the one or more side walls.

3. The support device of claim 1, further comprising adjustable side covers located on the one or more side walls, wherein the side covers are operable to modulate the light entering the interior space of the hollow body.

4. The support device of claim 1, wherein the one or more side walls include transparent or translucent materials, capable of filtering light to adjust the lighting conditions within the hollow body.

5. The support device of claim 1, wherein the one or more side walls include at least one opening equipped with a filter element, said filter element being interchangeable to provide different lighting effects within the interior space.

6. The support device of claim 1, wherein the bottom edge of the base portion includes indentations, protrusions, or a combination thereof, to enhance grip on the surface upon which the support device is placed.

7. The support device of claim 1, wherein the structure configured to retain the image capture device comprises a frame or platform with adjustable grip elements to accommodate different sizes and models of image capture devices.

8. The support device of claim 1, further comprising adhesive parts located on the structure for securing the image capture device, wherein the adhesive parts are configured to prevent movement of the image capture device once installed.

9. The support device of claim 1, wherein the hollow body includes a foldable box-like structure at the top portion to facilitate the insertion and securing of the image capture device, with foldable flaps to adjust to the size of the image capture device.

10. The support device of claim 1, wherein the hollow body is made from a material selected from the group consisting of paper, plastic, wood, metal, fabric, biodegradable materials, and silicone, with the material being selected to provide a desired level of transparency or opacity.

11. The support device of claim 1, further comprising a base surface structure attached to the bottom edge of the base portion, the base surface including measurement markings to assist in the evaluation of dimensions of the subject being photographed.

12. The support device of claim 11, wherein the base surface further is further configured with mechanisms to prevent small objects from getting too close to the camera lens of the image capture device, thereby maintaining a fixed focus distance.

13. The support device of claim 1, wherein the hollow body is formed into a geometric shape, selected form the group consisting of: polygonal, circular, cylindrical, or elliptical, to accommodate different photographic requirements.

14. The support device of claim 1, further configured to work in conjunction with artificial intelligence models to optimize settings such as stability, lighting, distance, and zoom, thereby enhancing the quality of the captured images.

15. The support device of claim 14, wherein the artificial intelligence models include classifiers for image-quality assessment, deep learning models for assisting in the optimal positioning of the device, and deep learning-based pixel-level image fusion models to produce the final image.

16. A continuous flow biodegradable plastic production method comprising:
mixing biodegradable polymer materials with additives and modifiers in a mixing chamber;
extruding the polymer blend using a twin-screw extruder under controlled temperature and pressure conditions;
shaping the molten polymer into desired products using a shaping die assembly;
incorporating biodegradability-enhancing additives into the polymer blend during mixing to accelerate decomposition in natural environments;
automating monitoring and control systems to ensure consistent product quality and performance.
